(19) United States
(12) Patent Application Publication
(10) Pub. No.: US 2010/0094755 A1
(43) Pub. Date: Apr. 15, 2010

(54) PROVIDING PAYMENT DATA TOKENS FOR ONLINE TRANSACTIONS UTILIZING HOSTED INLINE FRAMES

(75) Inventor: Michael Kloster, Evanston, IL (US)

Correspondence Address: SUITER SWANTZ PC LLO, 14301 FNB PARKWAY, SUITE 220, OMAHA, NE, 68154, US

(73) Assignee: NELNET BUSINESS SOLUTIONS, INC., Lincoln, NE (US)

(21) Appl. No.: 12/576,603

(22) Filed: Oct. 9, 2009

Related U.S. Application Data
(60) Provisional application No. 61/195,632, filed on Oct. 9, 2008.

(51) Int. Cl. G06Q 40/00

(52) U.S. Cl. 705/44

(57) ABSTRACT

A method comprising providing an inline frame (iFrame) and secure cross domain messaging for collecting sensitive payment data regarding access to monies held for an end user, the iFrame is embedded directly within a website maintained by a business entity; collecting the sensitive payment data via the iFrame; storing the sensitive payment data in an electronic database; associating a payment data token with the sensitive payment data; providing the payment data token to the business entity; receiving a request from the business entity to transfer at least a portion of the monies to the business entity; receiving the payment data token from the business entity with the request; retrieving the sensitive payment data from the electronic database; and transferring the at least a portion of the monies to the business entity utilizing the retrieved sensitive payment data via a backend payment gateway.

### CROSS-REFERENCE TO RELATED APPLICATIONS

The present application claims priority based on Provisional Application Ser. No. 61/195,632 filed Oct. 9, 2008. Said Provisional Application Ser. No. 61/195,632 is hereby incorporated by reference in its entirety.

### TECHNICAL FIELD

The present disclosure generally relates to the field of electronic commerce, and more particularly to a system and method for providing payment data tokens for online transactions utilizing hosted inline frames.

### BACKGROUND

When conducting ecommerce (electronic commerce), online merchants often collect and store sensitive payment data regarding their customers (e.g., credit card numbers) utilizing a web page. Collecting such data may subject the online merchant to costly security audits and regulations. Further, the online merchant may be exposed to financial risk in the event of a security breach. Hosted payment screens allow a merchant to collect payments without collecting or storing sensitive payment data. However, the end user is redirected to a hosted payment screen where payment data is collected. Then, the user is redirected back to the online merchant's website after payment has been authorized. This is not a seamless process for the end user, and oftentimes the hosted payment screen must capture additional data which is not payment related (such as shipping costs).

### SUMMARY

Accordingly, an embodiment of the present disclosure is directed to a method. The method may comprise providing an inline frame for collecting sensitive payment data regarding access to monies held for an end user, the inline frame for embedding directly within a website maintained by a business entity having an online presence; collecting the sensitive payment data regarding the access to the monies held for the end user via the inline frame; storing the sensitive payment data in an electronic database; associating a payment data token with the sensitive payment data regarding the access to the monies held for the end user; providing the payment data token to the business entity; receiving a request from the business entity to transfer at least a portion of the monies held for the end user to the business entity; receiving the payment data token from the business entity with the request; retrieving the sensitive payment data regarding the access to the monies held for the end user from the electronic database; and transferring the at least a portion of the monies held for the end user to the business entity utilizing the retrieved sensitive payment data via a backend payment gateway, wherein the step of providing the payment data token to the business entity is performed before the step of receiving the request from the business entity to transfer at least a portion of the monies held for the end user to the business entity, allowing the business entity to validate information regarding the transaction prior to processing the transaction.

A further embodiment of the present disclosure is directed to a system. The system may comprise a payment system server for providing an inline frame for collecting sensitive payment data regarding access to monies held for an end user, the inline frame for embedding directly within a website maintained by a business entity having an online presence, the website configured for allowing the business entity to validate information regarding the sensitive payment data prior to processing the payment; a network interface for collecting the sensitive payment data regarding the access to the monies held for the end user via the inline frame; memory for storing the sensitive payment data in an electronic database; the payment system server associates a payment data token with the sensitive payment data regarding the access to the monies held for the end user, wherein the network interface is utilized to provide the payment data token to the business entity; and a backend payment gateway for transferring at least a portion of the monies held for the end user to the business entity utilizing the sensitive payment data upon receiving a request from the business entity to transfer the at least a portion of the monies held for the end user to the business entity, receiving the payment data token from the business entity with the request, and retrieving the sensitive payment data regarding the access to the monies held for the end user from the electronic database.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram illustrating a system for providing payment data tokens for online transactions utilizing hosted inline frames in accordance with the present disclosure; and

FIG. 2 is a flow diagram illustrating a method for providing payment data tokens for online transactions utilizing hosted inline frames in accordance with the present disclosure.

### DETAILED DESCRIPTION

Reference will now be made in detail to the subject matter disclosed, which is illustrated in the accompanying drawings.

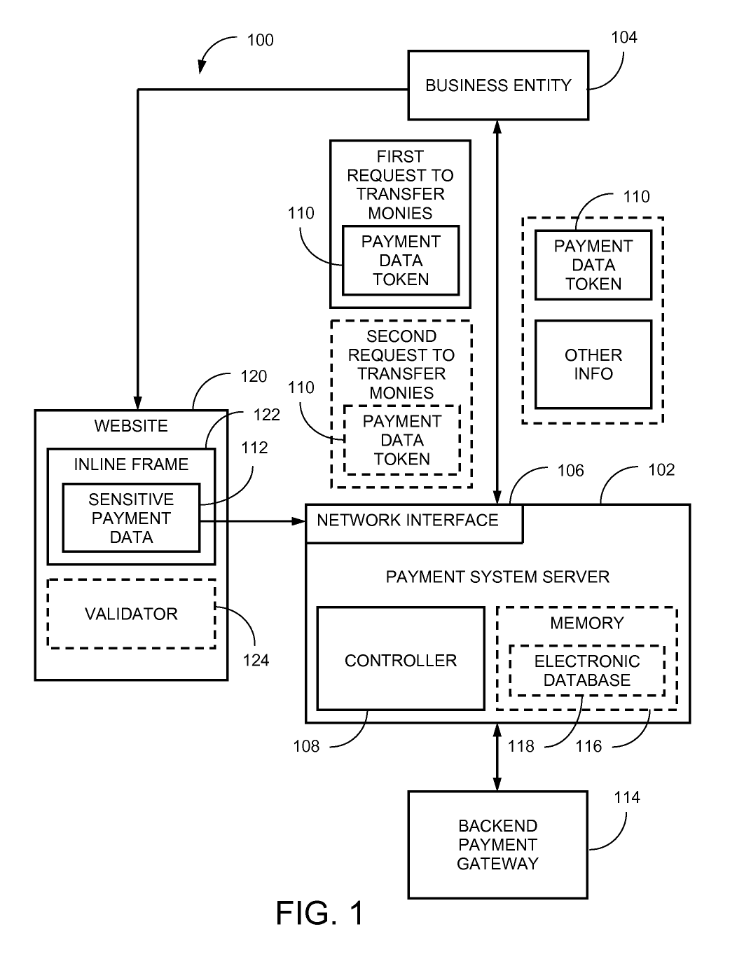

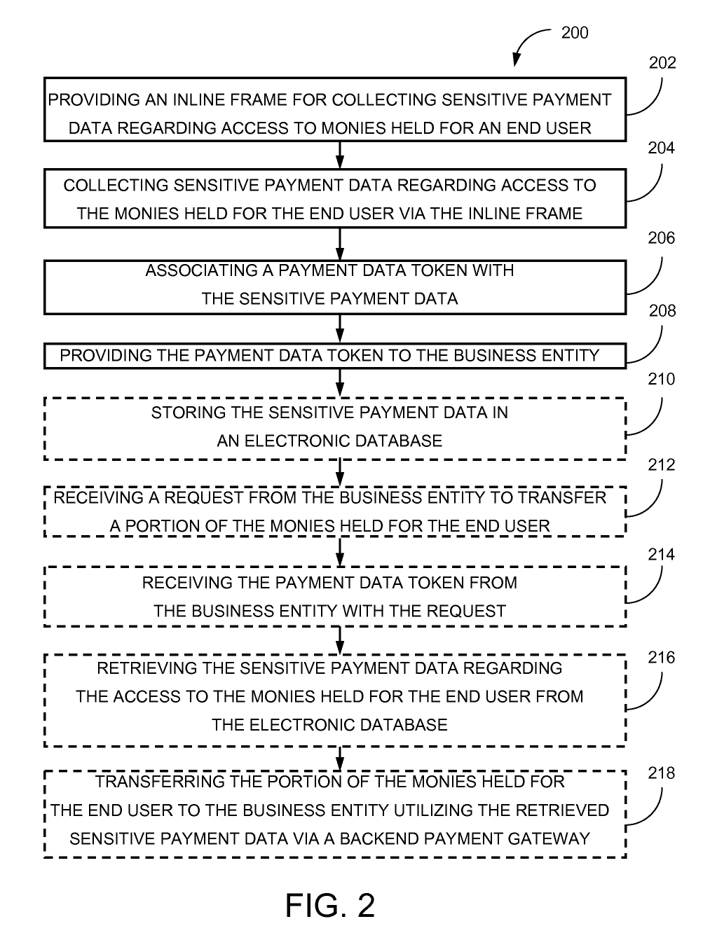

Referring generally to FIGS. 1 and 2, a system 100 and a method 200 for allowing an online merchant to accept payments over a computer network (e.g., the Internet) are illustrated in accordance with exemplary embodiments of the present disclosure.

Referring now to FIG. 1, a system 100 is described in accordance with the present disclosure. The system 100 includes a payment system server 102 for processing one or more payments for a merchant (e.g., a business entity 104 having an online presence). The payment system server 102 includes a network interface 106 for communicating with the business entity 104 via a network (e.g., the Internet). For example, the network interface 106 may be utilized to receive a request to transfer monies from an end user (customer) to the business entity 104. The payment system server 102 also includes controller 108 for associating a payment data token 110 with sensitive payment data 112 received from the customer.

In one embodiment, a payment data token is a system generated identifier comprised of a string of characters that may be utilized as a key to refer to sensitive payment data. For example, the identifier may comprise a numeric or alpha numeric sequence of characters of an arbitrary length. For instance, a test credit card number 5454545454545454 could be referenced by a payment data token 112232283219925454. This payment data token only has meaning within the payment system and could not be used to process payments at physical merchant locations or utilizing other websites. In one implementation, multiple different token patterns that a customer could select from may be offered, for instance, restricting the token to 16 numeric digits so that it would be similar to a credit card number.

The payment system server 102 is connected to a backend payment gateway 114 for processing transactions. For example, the payment system server may be connected to one or more backend payment gateways selected from the group comprising: Vital, Global Payments, Paymentech, and Authorize.NET. It will be appreciated that this list is not meant to be exclusive of the present disclosure, and other backend payment gateways may be utilized.

The payment system server 102 may provide the payment data token 110 to the business entity 104 (e.g., via the network interface 106). The payment data token 110 may be transmitted to an address specified by the online merchant utilizing secure cross-domain messaging. In one example of secure cross-domain messaging, the business entity 104 may provide the payment system server 102 with a call back Uniform Resource Locator (URL), and the payment system server 102 may pass the payment data token 110 as a parameter to the call back URL. The business entity 104 may then utilize the payment data token 110 to request one or more payments from the customer. Additionally, the payment system server 102 may include memory 116 for storing the sensitive payment data 112, the payment data token 110, and possibly other information regarding customers in an electronic database 118. In a specific instance, a unique payment data token 110 is associated with the sensitive payment data 112 for each end user stored in the electronic database 118. It is contemplated that other information may be stored by the electronic database and associated with one or more customers. For example, non-sensitive payment data, such as the name on the card, the expiration date, the billing address of the card, a phone number, an email address, as well as other information could be stored and associated with a particular user. Other information about the customer may be stored as well, such as the originating IP address of the user requesting the token, and/or user-agent information associated with the web browser utilized when requesting the token. Further, a unique customer identifier created by the merchant could also be stored for the customer. It is contemplated that any non-sensitive data could be retrieved via an inline frame or API calls by the merchant.

The business entity 104 hosts a website 120, such as an ecommerce (electronic commerce) site for selling goods and/or services. The payment system server 102 provides the business entity 104 with one or more inline frames 122 that can be directly hosted on the website 120. Each inline frame 122 is configured to communicate directly with the payment system server 102. For example, the customer may enter confidential information regarding an account and then submit the information. Thus, the inline frame 122 may be utilized to collect sensitive payment data 112 regarding a customer (e.g., regarding access to monies held for the customer). By embedding the inline frame 122 directly within the website 120 of the business entity 104, the payment system server 102 is able to receive sensitive payment data 112 from an end user without requiring the business entity 104 to collect the sensitive payment data 112. Further, the online merchant may host its own form(s), for capturing information that is not payment related, such as shipping costs, or the like. By providing one or more inline frames 122 for embedding directly in an online merchant's forms, the customer can submit form data hosted on two separate servers with a single click.

The method of the present disclosure may provide a secure cross domain messaging protocol to enable the merchants to control styling (e.g., page styles and layouts, etc.) and other attributes of the input fields within inline frames. The secure cross domain messaging protocol may also provide a mechanism for the merchants to receive validation information in real time. While the implementations of the secure cross domain messaging protocol may vary based on specific browsers, the secure cross domain messaging protocol and the inline frames may protect the merchants from capturing credit card data while still being able to interact with the inline frame to receive validation information as well as having the ability to style the elements to match the layout of the rest of the web page.

In one embodiment, the secure cross domain messaging protocol may be implemented as a hidden inline frame utilized for passing messages between the merchant website and iFrame elements. This may provide a powerful and seamless experience for the end user. It is understood that other message passing mechanisms may be utilized to implement the secure cross domain messaging protocol of the present disclosure. Such mechanisms may include, but not limited to, iFrame source redirect, dynamic iFrame creation/destruction, iFrame URL fragment identifier, HTML5 postMessage( ) and Flash.

In a specific example where iFrame is utilized as a messaging agent (by redirecting the src attribute of the frame or updating the URL fragment identifier) for the secure cross domain messaging protocol implementation, real time messaging may be provided as a customer enters data into payment system iFrame form elements. For example, if a customer begins by typing the number 5 into a credit card field, a message could be sent to the merchant's enclosing page that the user has begun entering a Mastercard number. The merchant could use that information to auto select Mastercard or use that information to display a validation error if the user had selected Visa as the card type. This same system could be utilized for reporting validation errors in real time (for instance if a credit card number does not pass the mod10 validation required for all credit card data). Similarly, the merchant could pass information into the payment system inline frames by using a messaging iFrame to indicate that a payment system input field should have the cursor focus. Combined, this use of secure cross-domain messaging with inline frames allows the merchant to shape the end user experience, in the same manner as they would if they collected the sensitive payment data in their own form inputs.

In a specific instance, the inline frame 122 is an iFrame comprising a first HTML element embedded in a second HTML element, such as the website 120. It is further contemplated that inline frames could be utilized as a temporary storage area to facilitate communication between payment system iframes.

By providing the business entity 104 with a payment data token 110, the payment system server 102 may provide an online merchant with one-time payment processing, customer data profile management, and/or recurring payment options without requiring the merchant to collect or store sensitive information, such as credit card numbers, or the like. Also, the website 120 may include validator 124, allowing the business entity 104 to validate information regarding a transaction prior to processing the transaction (i.e., prior to sending the payment data token 110 to the payment system server 102). In this manner, the end user may be provided with a seamless electronic transaction. For example, the business entity 104 may be able to provide a confirmation screen including data from the merchant's form, as well as payment data, before a transaction is processed. In embodiments, the validatior 124 may implement a confirmation screen, a pop-up window, and/or a message (e.g., “is this information correct?”). It is contemplated that many different types of validation could be utilized. For instance, a merchant may require a user to enter data into a field (such as daytime phone number). Merchants may require such data to be of a valid format (e.g., ###-###-####). Further, there may be conditional logic, such as when the country United States is selected, the user is then required to enter a state. It is also contemplated that a user may be alerted to a validation mistake. In such an instance, the answer could be an additional text alert on the screen and/or the highlighting of one or more incorrect fields.

Referring now to FIG. 2, a method 200 is described in accordance with the present disclosure. An inline frame is provided for collecting sensitive payment data regarding access to monies held for an end user. The inline frame may be configured for embedding directly within a website maintained by a business entity (merchant) having an online presence, 202. For example, an end user (customer) connects to the online merchant's website and navigates to a payment page. The business entity provides the payment page with form inputs from the website, as well as the inline frame. The customer then completes the form and electronically submits it.

The sensitive payment data regarding access to the monies held for the end user is collected via the inline frame, 204. Next, a payment data token is associated with the sensitive payment data regarding the access to the monies held for the end user, 206. The payment data token is provided to the business entity, 208. (The sensitive payment data may be stored in an electronic database, 210). For instance, in a specific implementation of secure cross domain messaging, the inline frame may be redirected to a call back URL specified by the merchant. In a specific example, the URL is in the same domain as the original payment page. Continuing the present example, the payment data token is passed as a parameter to the call back URL. The call back URL submits the merchant's form automatically (without additional action required by the customer).

A request is received from the business entity to transfer at least a portion of the monies held for the end user to the business entity, 212. The payment data token is received from the business entity with the request, 214. For instance, the merchant system validates the data entered by the customer on the payment form and, if valid, makes a backend call, passing the payment data token to represent the payment data for transacting the payment. Then, the sensitive payment data regarding the access to the monies held for the end user is retrieved from the electronic database, 216. Next, a portion of the monies held for the end user is transferred to the business entity utilizing the retrieved sensitive payment data via a backend payment gateway, 218. The backend payment gateway may respond indicating success or failure regarding the transaction.

It will be appreciated that when the step of providing the payment data token to the business entity is performed before the step of receiving the request from the business entity to transfer at least a portion of the monies held for the end user to the business entity, the business entity is allowed to validate information regarding the transaction prior to processing the transaction.

Further, if the online merchant would need to collect a payment again utilizing the same payment data (e.g., to renew a monthly subscription), the merchant may do so utilizing the same payment data token. For example, a second request may be received from the business entity to transfer at least a second portion of the monies held for the end user to the business entity. Then, the payment data token may be received from the business entity with the second request. Next, the sensitive payment data regarding the access to the monies held for the end user may be retrieved from the electronic database. Finally, a second portion of the monies held for the end user may be transferred to the business entity utilizing the retrieved sensitive payment data via the backend payment gateway.

In one embodiment, if the merchant utilizes a payment data token to collect a payment, a payment gateway proxy may be utilized for processing the request from the merchant. The payment gateway proxy may be configured for accepting inbound request which are in the format expected by other backend processors, such as Authorize.NET or Paymentech. In this manner, sensitive payment data (e.g., credit card number) which would have been included in the request from the merchant may be replaced by the payment data token instead. The payment gateway proxy may then substitute the sensitive payment data (e.g., credit card number) for the payment data token and forward the request to the appropriate backend processors. The advantage of this implementation is that the merchants may maintain their freedom to choose a backend processor of their choice while still have the security protection that is provided by the payment processing system of the present disclosure. It is contemplated that a payment gateway proxy may be utilized independent of the mechanism used for generating payment data tokens. For example, a system which utilizes hosted payment screens which are not embedded within an inline frame to capture payment data and return payment data tokens to a business entity may also make use of a payment gateway proxy.

It is further contemplated that the mechanisms utilized for the payment system, including the inline frame inputs, the secure cross-domain messaging and the gateway proxy, may be utilized for handling sensitive and/or critical data in other systems (e.g., in systems not limited to the field of payment processing) without departing from the spirit and scope of the present disclosure. For example, the inline frame inputs, the secure cross-domain messaging and the gateway proxy may be utilized in health care research or financial systems where sensitive data must be collected but that the collection of the data exposes business entities to costly regulation.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What we claim is:

1. A method, comprising:
providing an inline frame for collecting sensitive payment data regarding access to monies held for an end user, the inline frame for embedding directly within a website maintained by a business entity having an online presence;
collecting the sensitive payment data regarding the access to the monies held for the end user via the inline frame;
storing the sensitive payment data in an electronic database;
associating a payment data token with the sensitive payment data regarding the access to the monies held for the end user;
providing the payment data token to the business entity;
receiving a request from the business entity to transfer at least a portion of the monies held for the end user to the business entity;
receiving the payment data token from the business entity with the request;
retrieving the sensitive payment data regarding the access to the monies held for the end user from the electronic database; and
transferring the at least a portion of the monies held for the end user to the business entity utilizing the retrieved sensitive payment data via a backend payment gateway,
wherein the step of providing the payment data token to the business entity is performed before the step of receiving the request from the business entity to transfer at least a portion of the monies held for the end user to the business entity, allowing the business entity to validate information regarding the transaction prior to processing the transaction.

2. A system, comprising:
a payment system server for providing an inline frame for collecting sensitive payment data regarding access to monies held for an end user, the inline frame for embedding directly within a website maintained by a business entity having an online presence, the website configured for allowing the business entity to validate information regarding the sensitive payment data prior to processing the payment;
a network interface for collecting the sensitive payment data regarding the access to the monies held for the end user via the inline frame;
memory for storing the sensitive payment data in an electronic database;
the payment system server associates a payment data token with the sensitive payment data regarding the access to the monies held for the end user, wherein the network interface is utilized to provide the payment data token to the business entity; and
a backend payment gateway for transferring at least a portion of the monies held for the end user to the business entity utilizing the sensitive payment data upon receiving a request from the business entity to transfer the at least a portion of the monies held for the end user to the business entity, receiving the payment data token from the business entity with the request, and retrieving the sensitive payment data regarding the access to the monies held for the end user from the electronic database.
